(19) United States
(12) Patent Application Publication
(10) Pub. No.: US 2008/0223860 A1
(43) Pub. Date: Sep. 18, 2008

(54) Cookware

(76) Inventors: Stephen Graham Rutherford, Herfordshire (GB); James Harold Johns, Bedforshire (GB)

Correspondence Address: HAYES SOLOWAY P.C., 3450 E. SUNRISE DRIVE, SUITE 140, TUCSON, AZ, 85718, US

(21) Appl. No.: 11/817,670

(22) PCT Filed: Mar. 1, 2006
(86) PCT No.: PCT/GB06/00702

§ 371 Date: Oct. 22, 2007

(30) Foreign Application Priority Data
Feb. 3, 2005 (GB) 0504195.9

(51) Int. Cl. A47J 37/01; A47J 39/00

(52) U.S. Cl. 220/573.1; 426/523

(57) ABSTRACT

An article of cookware for use in an oven, wherein the artiste of cookware comprises a base having an upper surface, wherein at least a first region of the upper surface incorporates a plurality of upward protrusions, and wherein the uppermost regions of said protrusions are substantially coplanar for supporting a food product for cooking. Preferably the upper surface between said protrusions is inclined relative to the uppermost regions of said protrusions. A gutter may be provided around at least part of said first region, arranged such that liquid released from a foodstuff during cooking flows into the gutter. The invention further provides a method of cooking using an oven and such an article of cookware.

This invention relates to cookware, including (but by no means limited to) domestic cookware and commercial cookware.

The invention is particularly applicable to the cooking of meat products, although it should be emphasised that it is also highly applicable to the cooking of non-meat products, for example vegetables, pies, pizzas and pasties.

### BACKGROUND TO THE INVENTION

In both domestic kitchens and commercial catering establishments (e.g. restaurants, cafeterias, etc.) there is a desire to reduce the cooking time for foodstuffs.

Developments in oven technology have enabled progress to be made in reducing the cooking time for foodstuffs. For example, forced air/microwave combination ovens are now in common usage, one popular model being the TurboChef C3 oven (supplied by TurboChef Technologies, Inc., of 10500 Metric Drive, Suite 128, Dallas, Tex. 75243, USA). Such ovens are typically found in petrol stations, motorway service area cafeterias and roadside restaurants, and are used for cooking or defrosting a wide range of foods such as pizzas, hot filled baguettes, lasagne, steak, fish, burgers and pies. The ovens use a combination of rapidly-moving electrically-heated hot air and microwave radiation to cook food placed therein. The TurboChef C3 can reach a cooking temperature of 275° C., and cooks on average at seven times the speed of a conventional oven.

Domestic ovens may also be fan-assisted, to achieve a more uniform cooking temperature throughout the oven and to aid the cooking of food by the circulation of hot air.

Despite such developments in oven technology, there remains a desire to accelerate further the cooking process. For example, in commercial catering establishments, this would, enable customers to be served even more quickly. Additionally, a shorter cooking time enables less energy to be used for the cooking process, thereby benefiting the environment and reducing the cost of running the oven.

For health reasons, it is also desirable to cook food in a manner such as to produce a cooked product that is low in fat.

The term “cookware” as used herein is intended to encompass any plate, dish, bowl, box, carton, tray or other receptacle on (or in) which food is placed when being defrosted or cooked. Cleaning cookware after use can be problematic. Traditionally, cookware used in forced air/microwave combination ovens has been pressed from cardboard, and is known as “pressware”. Cardboard is permeable to microwave radiation, and is therefore suitable for this purpose. However, each item of traditional cardboard pressware is only used once, and is then discarded. It is not possible to reuse cardboard pressware after cooking, since it becomes coated with cooked food (e.g. baked-on molten cheese) and cannot be cleaned (otherwise the cardboard becomes soggy and unusable). Given the vast numbers of meals that are prepared every year using cardboard pressware that is disposed after use, its use is not environmentally friendly and is far from ideal. There is therefore a strong desire for cookware that is both reusable and readily cleanable.

### SUMMARY OF THE INVENTION

According to a first aspect of the invention there is provided an article of cookware for use in an oven, wherein the article of cookware comprises a base having an upper surface, wherein at least a first region of the upper surface incorporates a plurality of upward protrusions, and wherein the uppermost regions of said protrusions are substantially coplanar for supporting a food product for cooking.

During cooking, when food is placed on the protrusions, the food is thereby raised from the upper surface of the cookware, and this has the advantageous effect of enhancing airflow over the cookware and under the food. This in turn expedites the cooking of the food and conserves energy. The uppermost regions of the protrusions, being substantially coplanar (i.e. extending to a common height), collectively provide a substantially flat surface on which to place the food product for cooking.

The term “protrusions” should be interpreted broadly, to encompass inter alia discrete raised points, raised ribs and ridges.

Preferably the upper surface between said protrusions is inclined relative to the uppermost regions of said protrusions. When cooking food placed on the protrusions, and particularly when cooking meats, this advantageously enables liquids released from the food (and in particular fats and juices released from meat) to drain away between the protrusions. By separating liquid fats from the foodstuff in this manner, the resulting cooked product is lower in fat and more healthy to eat.

Preferably the upper surface between said protrusions has a curved or convex profile, relative to an imaginary plane formed by the uppermost regions of said protrusions, the upper surface being nearer to said imaginary plane in substantially the centre of said first region, and further from said imaginary plane towards the edge of said first region. This enables the liquid released from the food during cooking to drain in opposing directions towards the edge of the cookware.

Preferably the article of cookware further comprises an undersurface, wherein the undersurface has a curved profile substantially parallel to the profile of the upper surface between said protrusions. This advantageously facilitates the manufacture of the cookware.

Preferably the lowermost regions of the undersurface define a plane of contact between the article of cookware and a surface on which it is supported in use, said plane of contact being parallel to the uppermost regions of said protrusions. This advantageously results in the uppermost regions of said protrusions (and hence food placed thereon) being parallel to the surface on which the cookware is supported during cooking.

Particularly preferably the article of cookware further comprises a gutter around at least part of said first region. This gutter advantageously collects liquids released from the food during cooking. Depending on the dimensions of the product, the gutter may also be used for holding other food products, such as potatoes, during cooking.

The gutter may extend around substantially the perimeter of the article. Particularly preferably the upper surface between said protrusions is arranged such that liquid released from a foodstuff during cooking flows into the gutter.

One or more upward protrusions may be provided within the gutter. These may advantageously be used to support vegetables such as potatoes placed within the gutter for cooking. It has been found that pleasantly-cooked roast potatoes may be obtained in this manner, when meat is being cooked on the first region of the article: The fats and juices from the meat are able to flow into the gutter, which aids the cooking of the potatoes whilst reducing the fat content of the meat. At the same time, the one or more protrusions within the gutter support the potatoes, holding them above the base of the gutter and enabling the fats and juices to flow under the potatoes. This results in the potatoes becoming only lightly coated with the fat (giving a desirable crispy coating), rather than allowing them to be soaked in fat which would render them unpleasant and unhealthy to eat.

The said one or more upward protrusions within the gutter may comprise a ridge within the gutter and extending parallel to the gutter. Said ridge may extend along the entirety of the gutter.

Preferably said plurality of upward protrusions incorporated within said first region of the upper surface are in the form of ridges or ribs. Said ridges or ribs may extend over substantially the entirety of said first region of the upper surface, and may be substantially parallel, or alternatively may be arranged in a star formation or some other configuration. It has been found that, if moulding the article from a plastics material, continuous or semi-continuous ridges or ribs are in some instances easier to form than discrete protrusions. Additionally, continuous or semi-continuous ridges or ribs advantageously define channels along which liquids released from the food during cooking can flow. Continuous or semi-continuous ridges or ribs are also easier to clean than discrete protrusions. Furthermore, the ridges or ribs help to strengthen the article of cookware, and make it less susceptible to distortion, both during manufacture and when being used for cooking.

Preferably the article of cookware further comprises a side wall extending at least partially around the article. The side wall may form a wall of the gutter.

Preferably the side wall incorporates a lip or recess for receiving a lid or cover. This advantageously enables the cookware to be covered for the cooking of certain types of food.

The side wall may further incorporate one or more handles. Such handles facilitate the lifting of the cookware article. This is particularly beneficial to domestic users, who may not otherwise have a suitable implement with which to move the article.

In some embodiments the height of the uppermost regions of said protrusions may be greater than or approximately equal to 50% of the height of the side wall. This advantageously results in the side walls not restricting hot air flow around food placed on said protrusions.

In further embodiments the height of the uppermost regions of said protrusions may be higher than the side wall, thereby providing completely unimpeded airflow around the food.

Preferably the article of cookware is made of a polymer material. Preferably the polymer material is a liquid crystal polymer resin reinforced with glass. Particularly preferably the article of cookware is made of DuPont (RTM) Zenite (RTM) 7130. Advantageously, such materials are easy to clean and may be soaked in water without detriment.

It should be emphasised that this disclosure is intended to apply to and encompass the use of alternative polymer materials that are suitable for cooking purposes, including polymer materials that have yet to be invented or developed.

Preferably the article of cookware has a unitary construction, obtained for example by casting or moulding. Moulding is particularly preferred if the article is made of a plastics material.

The article of cookware may be of a type selected from a group comprising: plate, dish, bowl, box, carton, tray. This list is not intended to be exhaustive, and this disclosure is intended to apply to other types of cookware, including types that have yet to be invented or developed.

According to a second aspect of the invention there is provided a method of cooking using an oven and an article of cookware in accordance with the first aspect of the invention.

### BRIEF DESCRIPTION OF THE DRAWINGS

Embodiments of the invention will now be described, by way of example, and with reference to the drawings in which:

FIG. 1 illustrates a plan view from above of a first embodiment (a roasting dish);

FIG. 2 illustrates a cross-sectional view (A-A) of the embodiment of FIG. 1;

FIG. 3 illustrates another cross-sectional view (AA-AA) of the embodiment of FIG. 1;

FIGS. 4a and 4b illustrate enlarged views of regions B and C respectively of FIG. 2;

FIG. 5 illustrates a plan view from below of the embodiment of FIG. 1;

7

FIG. 6 illustrates a plan view from above of a second embodiment (a cooking plate with handles);

FIG. 7 illustrates a cross-sectional view (A-A) of the embodiment of FIG. 6;

FIG. 8 illustrates another cross-sectional view (AA-AA) of the embodiment of FIG. 6;

FIGS. 9a and 9b illustrate enlarged views of regions B and C respectively of FIG. 7;

FIG. 10 illustrates a plan view from below of the embodiment of FIG. 6;

FIG. 11 illustrates a plan view from above of a third embodiment (a cooking plate without handles);

FIG. 12 illustrates a cross-sectional view (A-A) of the embodiment of FIG. 11;

FIG. 13 illustrates another cross-sectional view (AA-AA) of the embodiment of FIG. 11;

FIGS. 14a and 14b illustrate enlarged views of regions B and C respectively of FIG. 12; and

FIG. 15 illustrates a plan view from below of the embodiment of FIG. 11.

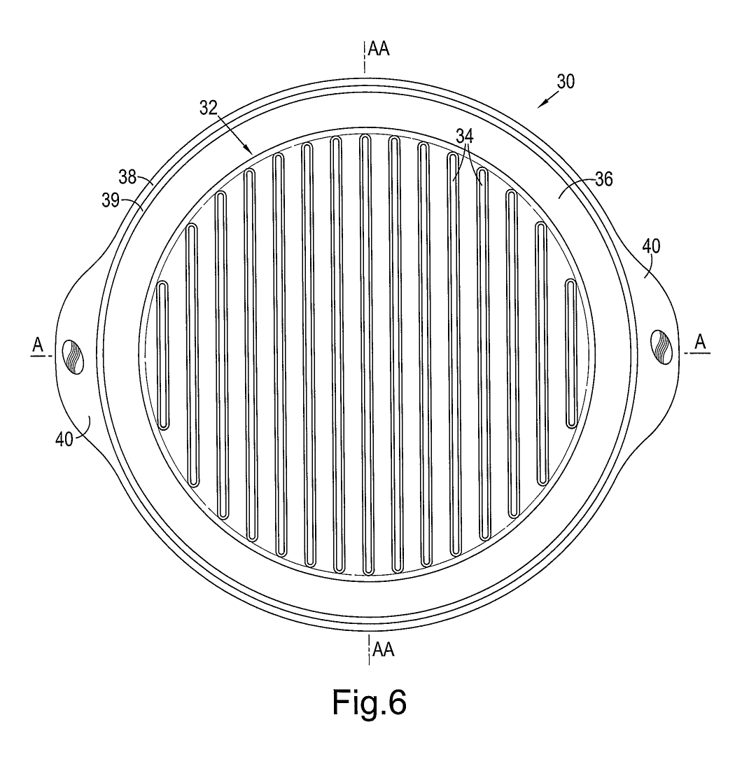

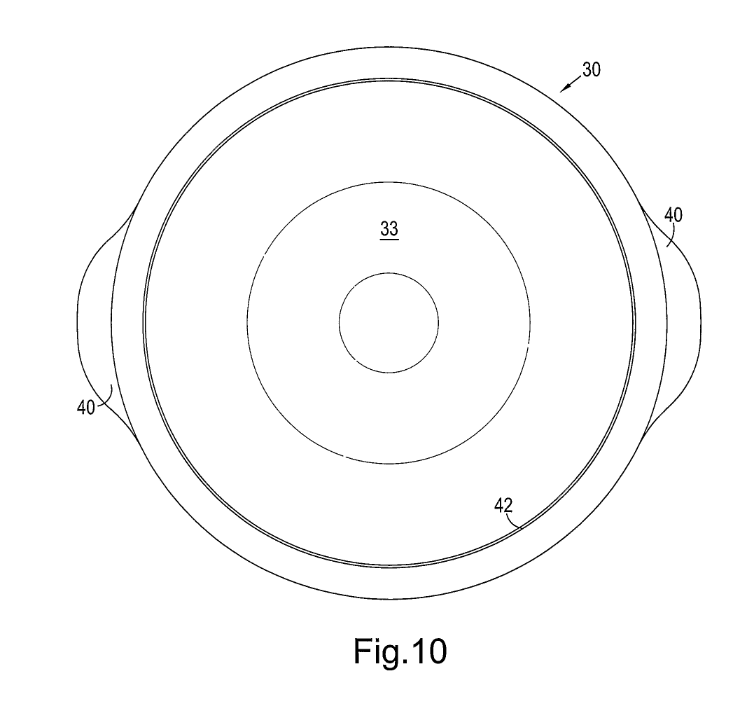

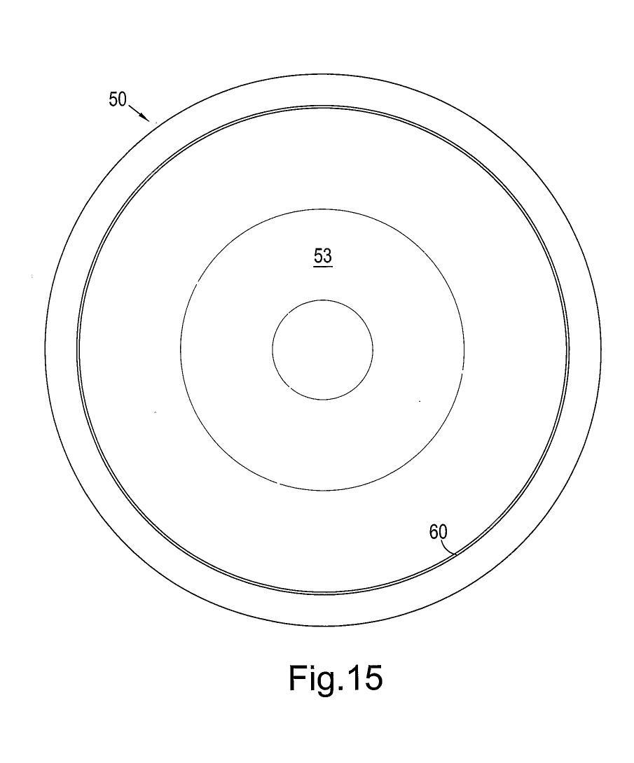

The dimensions in FIGS. 6 to 15 inclusive are provided by way of example only, as all the products may be made in a variety of shapes and sizes.

### DETAILED DESCRIPTION OF PREFERRED EMBODIMENTS

The present embodiments represent the best ways known to the applicant of putting the invention into practice. However they are not the only ways in which this can be achieved.

The embodiments of the invention that will now be described are presently preferably made from DuPont (RTM) Zenite (RTM) 7130, a liquid crystal polymer resin reinforced with 30% glass that is able to withstand temperatures of up to 289° C., which is well in excess of the maximum operating temperature of the TurboChef C3 oven, and is also suitable for domestic cooking. This material is well suited to injection moulding, thereby enabling the intricate shapes of cookware described herein to be readily formed. Highly advantageously, and in marked contrast to traditional cardboard pressware, resin cookware can easily be cleaned or soaked in water without detriment. This enables the cookware to be reused, thereby reducing continuous expenditure on cardboard pressware, and helping to conserve natural resources.

Other materials suitable for use in ovens may be used instead of DuPont (RTM) Zenite (RTM), and the present disclosure is intended to apply to and encompass all suitable materials already in existence and those which have yet to be discovered or developed, such as advanced engineering polymers, glasses, ceramics and composite materials. For example, DuPont (RTM) Thermx (RTM), a high performance polyester, may be used as an alternative to Zenite (RTM).

### Embodiment 1

### A Roasting Dish

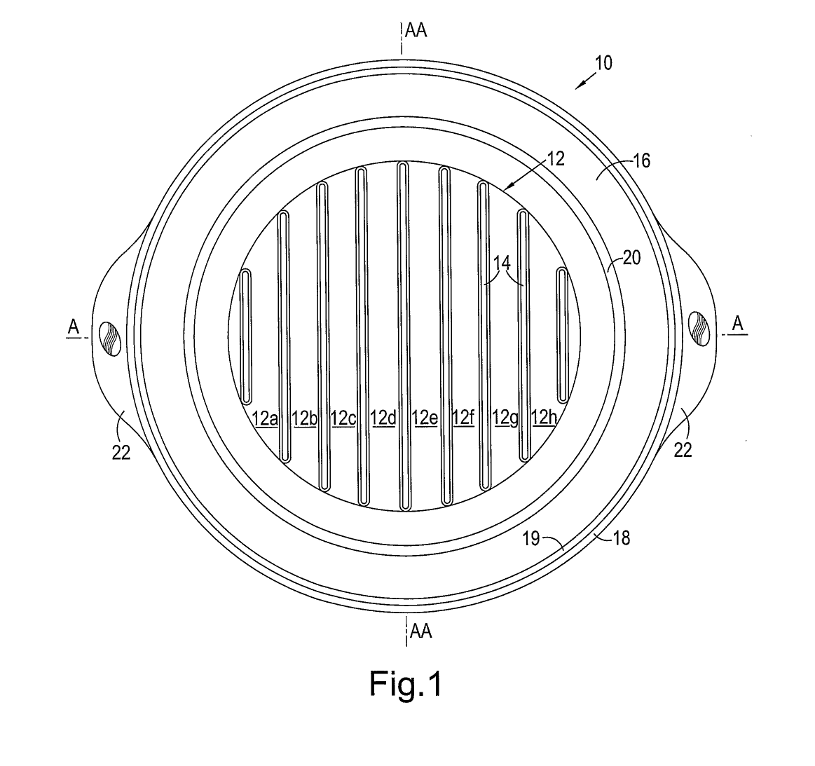

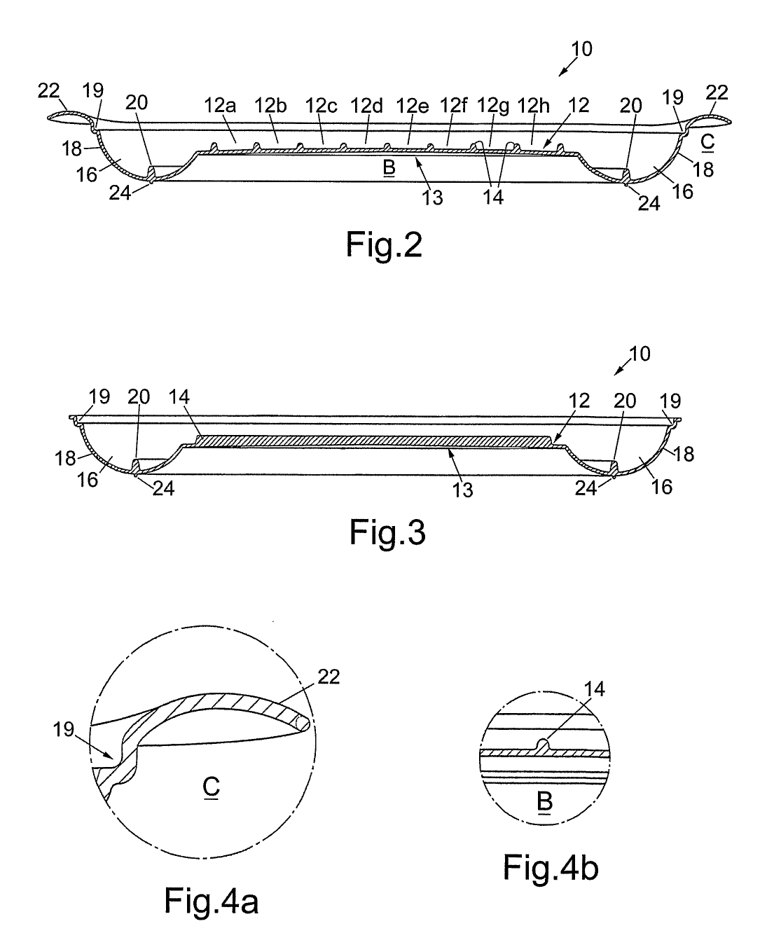

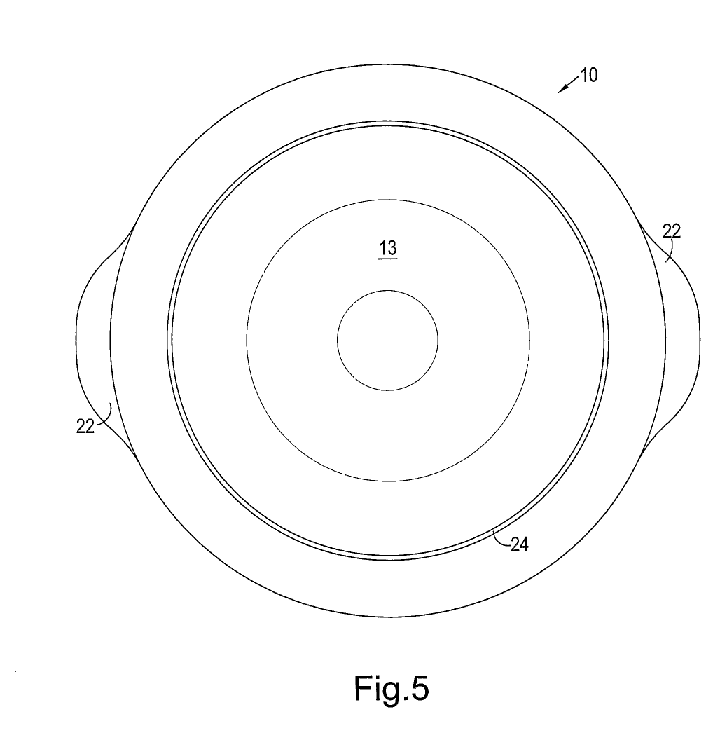

A first embodiment of the invention, as shown in FIGS. 1, 2, 3, 4a, 4b and 5, is a roasting dish 10 which may be used for cooking high fat products such as meats. The roasting dish 10 has a first region 12 in the centre of the upper surface of the dish, which incorporates a plurality of upward protrusions 14, in this example having the form of parallel ridges or ribs extending continuously from substantially one side of the central region 12 to the other. As shown in FIG. 2, the uppermost regions of the ridges 14 extend upwards to a common height, thereby (in combination) forming a substantially coplanar surface (which may be considered as an imaginary plane) on which a food product may be placed for cooking.

Other configurations of protrusions, ridges or ribs 14 are possible. For example, discrete protrusions (e.g. circular in cross-section) may be used. Alternatively, semi-continuous ridges may be used (i.e. lines of elongate ridges separated by gaps within each line). Instead of being arranged in a parallel configuration, continuous or semi-continuous ridges may alternatively be arranged in other patterns, such as in a star-shape, for example. Parallel ridges however have been found to be easier to clean, since the paths between the ridges are straight and are thereby easier to run a cleaning implement along.

By raising food placed on the ridges 14 from the upper surface of the cookware, the ridges 14 enhance airflow over the upper surface of the roasting dish 10 (i.e. between the ridges) and under the food. The improved airflow around the food (when compared to traditional roasting dishes or cardboard pressware) enables the food to cook quicker and more efficiently, using less energy. The food is also cooked more evenly, and in many cases there is no need to turn the food product during cooking.

The ridges 14 on the upper surface also enhance the flexural strength and rigidity of the cookware, particularly if it is made from a plastics material.

As shown in FIGS. 2 and 3, the central region 12 of the upper surface is inclined (in this case, arced in a curved or convex configuration) relative to the common height of the tops of the ridges 14. The undersurface 13 is also similarly arced, such that its profile is approximately parallel to that of the upper surface.

A gutter 16 is provided around the entire perimeter of the central region 12 (although in other embodiments the gutter may extend around only part of the central region). The central region 12 is raised relative to the base of the gutter 16. Here the outer wall of the gutter also serves as the side wall 18 of the roasting dish 10, although a side wall separate from the gutter may be provided in alternative embodiments. Handles 22 may be provided on either side of the cookware, extending outwards from the side wall 18, to facilitate lifting of the cookware by the user. A lip or recess 19 may be provided around the side wall 18 to receive a lid or cover, which may be used to cover the food during cooking.

By virtue of the central region 12 of the upper surface being inclined or curved relative to the uppermost surface of the ridges 14, liquid fats and juices released from a food product such as meat (placed on the ridges 14) during cooking drain along the channels between the ridges (e.g. channels 12a, 12b, 12c, 12d, 12e, 12f, 12g and 12h in FIG. 2) and into the gutter 16. Thus, the liquids fats and juices are separated from the food during cooking, resulting in the cooked product being lower in fat and healthier to eat than if the fats and juices had been allowed to remain in contact with the food.

Additionally, it has been found that, by separating the fats and juices from the food product and draining them into the gutter 16, less spitting of fats takes place within the oven, and this means that less cleaning of the oven is required after cooking. It is believed that fats may be more prone to spitting when in contact with the food, which may be due to the relatively high specific heat capacity of certain foods and the often-irregular shape of the food providing a plurality of sites from which fat may spit during cooking. However, by separating the fats into the gutter 16, they have been found generally to collect within the gutter, and not spit around the oven.

The gutter 16 around the side of the cookware also helps to increase the flexural strength and rigidity of the cookware in all directions.

In the example of the roasting dish 10, a ridge 20 is provided within the gutter 16. This ridge 20 adds strength and rigidity to the roasting dish, particularly when the dish is made from a plastics material. In the example shown in the figures, the ridge 20 is continuous around the entirety of the gutter 16, although this need not be the case and the ridge may be made semi-continuous or may take some other configuration.

Food may also be cooked within the gutter 16. For example, when cooking a traditional British meal including roast meat and potatoes, meat can be placed on the ridges 14, and potatoes can be placed within the gutter 16, supported by the ridge 20. With this arrangement, the fats and juices from the meat are able to flow into the gutter 16, which aids the cooking of the potatoes whilst reducing the fat content of the meat. At the same time, the ridge 20 within the gutter 16 support the potatoes, holding them above the base of the gutter 16 and enabling the fats and juices to flow under the potatoes. This results in the potatoes becoming only lightly coated with the fat (giving a desirable crispy coating), rather than allowing them to be soaked in fat which would render them unpleasant and unhealthy to eat. The ridge 20 also stops the potatoes from sticking to the base of the gutter 16.

As shown in FIGS. 2, 3 and 5, the underside of the cookware incorporates a downwardly-extending protrusion 24, here positioned on the underside of gutter 16. This protrusion 24, which may take the form of a continuous annular ridge, or discrete protrusions or a semi-continuous ridge, defines a plane of contact between the article of cookware and a surface on which it is placed in use. This plane of contact is parallel to the uppermost regions of the protrusions/ridges 14 on the upper surface of the cookware. This results in food placed on the ridges 14 being parallel to the surface on which the cookware is placed.

As indicated in FIGS. 2 and 3, with the roasting dish 10, it should be noted that the height of the uppermost surface of the ridges 14 in the central cooking region 12 is over 50% of the overall height of the dish 10. This enables the gutter 16 to be comparatively deep, to collect the liquid fat and juices released from high-fat products, and also provides the benefit that the side walls 18 do not restrict hot air flow around food placed on the ridges 14 in the central region 12. In alternative embodiments the central cooking region 12 or the upper surface of the ridges 14 may be even higher, above the height of the side wall 18 or handles 20, thereby providing completely unimpeded airflow around the food.

### Embodiment 2

### A Cooking Plate (With Handles)

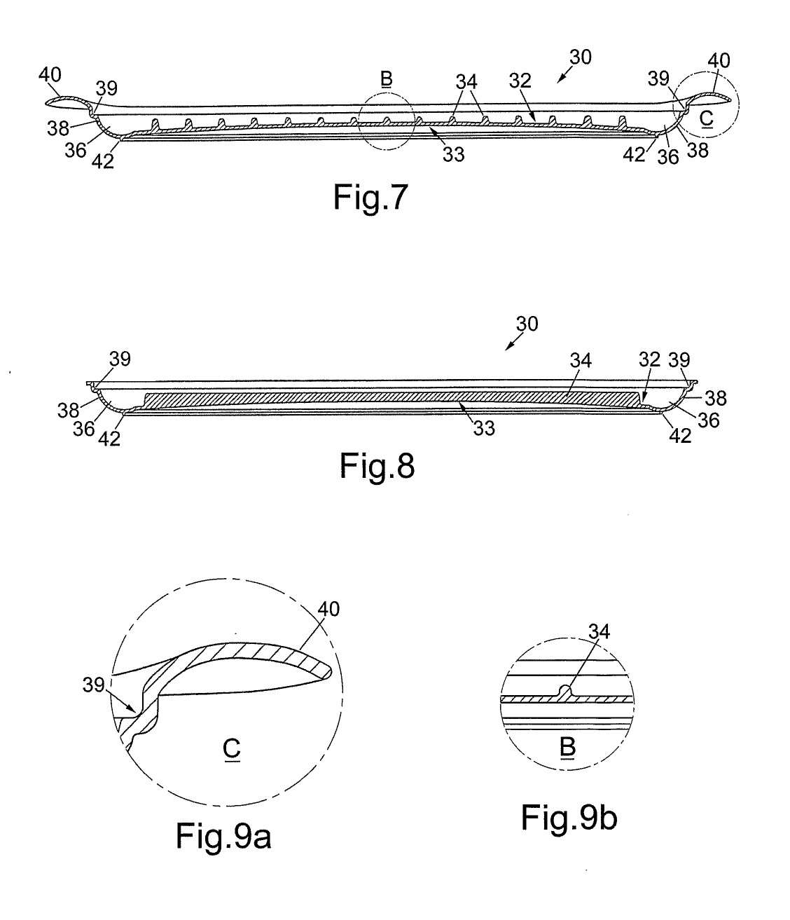

A second embodiment of the invention, as shown in FIGS. 6, 7, 8, 9a, 9b and 10, is a cooking plate 30, suitable for cooking foods such as fish or vegetables. The plate 30 has a cooking region 32 in the centre of the upper surface of the plate, which incorporates a plurality of continuous parallel ridges 34. As shown in FIG. 7, the uppermost regions of the ridges 34 extend upwards to a common height, thereby (in combination) forming a substantially coplanar surface on which a food product may be placed for cooking. As with the roasting dish 10 described previously, the ridges 34 need not be parallel or continuous (when seen in plan view), and other arrangements are possible.

The central region 32 of the upper surface is inclined (in this case, arced in a curved or convex configuration) relative to the common height of the tops of the ridges 34. The undersurface 33 is also similarly arced, such that its profile is approximately parallel to that of the upper surface.

A gutter 36 is provided around the entire perimeter of the central region 32, and the central region 32 is raised relative to the base of the gutter 36. A side wall 38 extends around the perimeter of the article 30, incorporating a lip 39 for receiving a cover or lid, and handles.40 to aid lifting. A downwardly-extending annular ridge 42 is provided on the undersurface of the gutter 36 to define a plane of contact between the cooking plate 30 and a surface on which it is placed in use.

As in the case of the roasting dish 10, the central region 32 of the upper surface is inclined or curved relative to the uppermost surface of the ridges 34, enabling liquid released from food during cooking to flow into the gutter 36.

Because the plate 30 is principally intended for the cooking of lower-fat products than the roasting dish 10, the gutter 36 is less deep than gutter 16, since less liquid fat is expected to be released from the food product during cooking. Additionally, no ridge is provided within the gutter 36, since in this embodiment it is not intended that additional foods will be cooked within the gutter 36 itself.

### Embodiment 3

### A Cooking Plate (Without Handles)

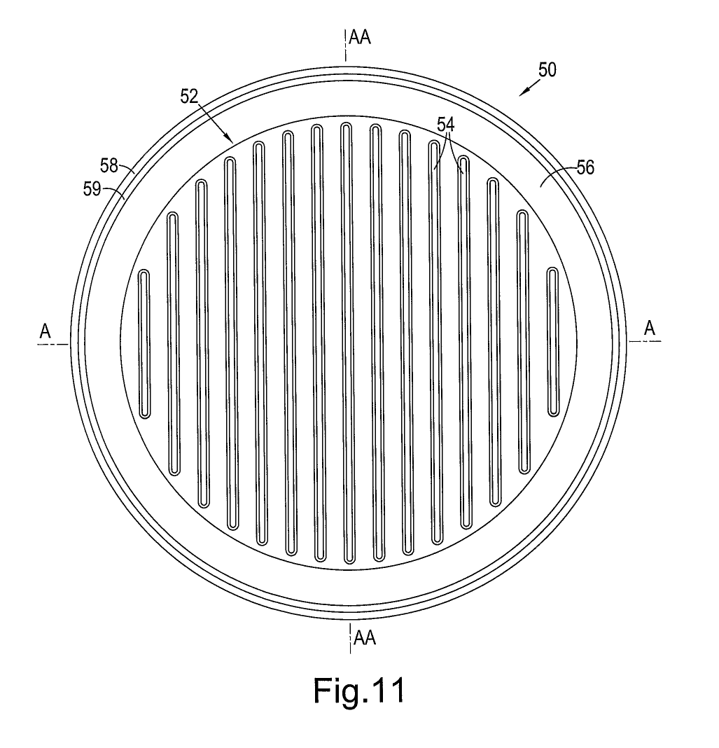

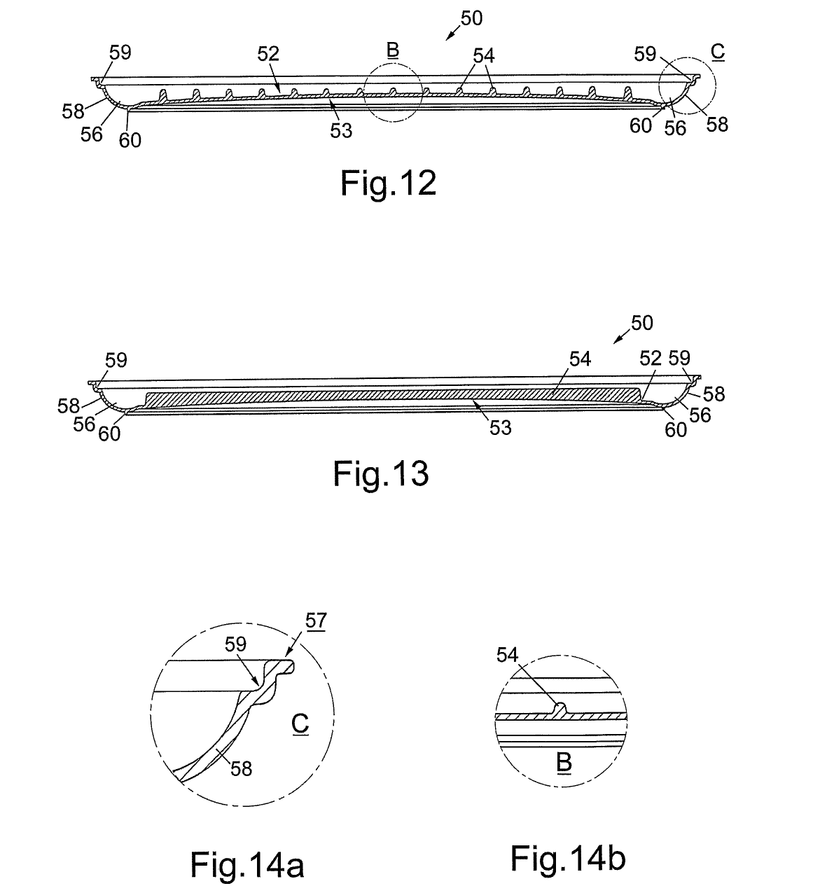

A third embodiment of the invention, as shown in FIGS. 11, 12, 13, 14a, 14b and 15, is another cooking plate 50, in this case not having handles. The plate 50 has a cooking region 52 in the centre of the upper surface of the plate, which incorporates a plurality of continuous parallel ridges 54. As shown in FIG. 12, the uppermost regions of the ridges 54 extend upwards to a common height, thereby (in combination) forming a substantially coplanar surface on which a food product may be placed for cooking. As with the embodiments described previously, the ridges 54 need not be parallel or continuous, and other arrangements are possible.

The central region 52 of the upper surface is inclined (in this case, arced in a curved or convex configuration) relative to the common height of the tops of the ridges 54. The undersurface 53 is also similarly arced, such that its profile is approximately parallel to that of the upper surface.

A gutter 56 is provided around the entire perimeter of the central region 52, and the central region 52 is raised relative to the base of the gutter 56. A side wall 58 extends around the perimeter of the article 50, incorporating a lip 59 for receiving a cover or lid. An outer rim 57 may also be provided, as shown in FIG. 14a. A downwardly-extending annular ridge 60 is provided on the undersurface of the gutter 56 to define a plane of contact between the cooking plate 50 and a surface on which it is placed in use.

As in the embodiments described previously, the central region 52 of the upper surface is inclined or curved relative to the uppermost surface of the ridges 54, enabling liquid released from food during cooking to flow into the gutter 56.

As a general point, although the embodiments described above are substantially circular in shape (when seen in plan view), cookware in accordance with the present invention may take any shape—e.g. rectangular, square or oval.

### Test Results

The roasting dish 10 of FIGS. 1 to 5 was tested in a domestic oven to cook meat. It was found that the cooking time for the meat was able to be reduced by 25% compared to tests in which conventional cookware was used, at the same oven temperature. Thus, not only is the cooking process substantially expedited, but energy is also saved by virtue of the oven being operational for less time. Additionally, less spitting of liquid fat around the inside of the oven was observed.

1. An article of cookware for use in an oven, wherein the article of cookware comprises a base having an upper surface, wherein at least a first region of the upper surface incorporates a plurality of upward protrusions, and wherein the uppermost regions of said protrusions are substantially coplanar for supporting a food product for cooking.

2. An article of cookware as claimed in claim 1, wherein the upper surface between said protrusions is inclined relative to the uppermost regions of said protrusions.

3. An article of cookware as claimed in claim 2, wherein the upper surface between said protrusions has a curved profile relative to an imaginary plane formed by the uppermost regions of said protrusions, the upper surface being nearer to said imaginary plane in substantially the centre of said first region, and further from said imaginary plane towards the edge of said first region.

4. An article of cookware as claimed in claim 3, further comprising an undersurface, wherein the undersurface has a curved profile substantially parallel to the profile of the upper surface between said protrusions.

5. An article of cookware as claimed in claim 1, wherein the lowermost regions of the undersurface define a plane of contact between the article of cookware and a surface on which it is supported in use, said plane of contact being parallel to the uppermost regions of said protrusions.

6. An article of cookware as claimed in claim 1, further comprising a gutter around at least part of said first region.

7. An article of cookware as claimed in claim 6, wherein the gutter extends around substantially the perimeter of the article.

8. An article of cookware as claimed in claim 3, further comprising a gutter around at least part of said first region wherein the upper surface between said protrusions is arranged such that liquid released from a foodstuff during cooking flows into the gutter.

9. An article of cookware as claimed in claim 6, further comprising one or more upward protrusions within the gutter.

10. An article of cookware as claimed in claim 9, wherein the said one or more upward protrusions within the gutter comprises a ridge within the gutter and extending parallel to the gutter.

11. An article of cookware as claimed in claim 10, wherein said ridge extends along the entirety of the gutter.

12. An article of cookware as claimed in claim 1, wherein said plurality of upward protrusions incorporated within said first region of the upper surface are in the form of ridges.

13. An article of cookware as claimed in claim 12, wherein said ridges extend over substantially the entirety of said first region of the upper surface.

14. An article of cookware as claimed in claim 13, wherein said ridges are substantially parallel.

15. An article of cookware as claimed in claim 1, further comprising a side wall extending at least partially around the article.

16. An article of cookware as claimed in claim 15, further comprising a gutter around at least part of said first region, wherein the side wall forms a wall of the gutter.

17. An article of cookware as claimed in claim 15, wherein the side wall incorporates a lip or recess for receiving a lid.

18. An article of cookware as claimed in claim 15 wherein the side wall further incorporates one or more handles.

19. An article of cookware as claimed in claim 15, wherein the height of the uppermost regions of said protrusions is greater than or approximately equal to 50% of the height of the side wall.

20. An article of cookware as claimed in claim 19, wherein the height of the uppermost regions of said protrusions is higher than the side wall.

21. An article of cookware as claimed in claim 1, made of a polymer material.

22. An article of cookware as claimed in claim 21, wherein the polymer material is a liquid crystal polymer resin reinforced with glass.

23. An article of cookware as claimed in claim 22, made of DuPont (RTM) Zenite (RTM) 7130.

24. An article of cookware as claimed in claim 1, having a unitary construction.

25. An article of cookware as claimed in claim 1, being of a type selected from a group comprising: plate, dish, bowl, box, carton, tray.

26. A method of cooking using an oven and an article of cookware as claimed in claim 1.

27-28. (canceled)
